(19) United States
(12) Patent Application Publication
(10) Pub. No.: US 2013/0346858 A1
(43) Pub. Date: Dec. 26, 2013

(54) Remote Control of Audio Application and Associated Sub-Windows

(71) Applicant: Paul Neyrinck, San Francisco, CA (US)

(72) Inventor: Paul Neyrinck, San Francisco, CA (US)

(73) Assignee: NEYRINCK LLC, San Franciswco, CA (US)

(21) Appl. No.: 13/532,485

(22) Filed: Jun. 25, 2012

(51) Int. Cl. G06F 3/0484

(52) U.S. Cl. CPC G06F 3/04847
USPC 715/716

(57) ABSTRACT

A method includes receiving a first input for controlling a first control in a first window for an audio application running on a main computing device being remotely controlled by a remote computing device. The method routes the first input to the audio application as a control message to have the application perform the first input. The application controls the first control based on the first input to control a first characteristic of an audio recording. A second input is received for controlling a second control in a sub-window for the audio application. The sub-window is concurrently displayed on the main computing device with the first window and includes a second set of controls and the second input is a movement of the second control on the remote computing device. The method causes the movement to be applied to the second control in the sub-window via a mouse event.

### BACKGROUND

In the audio industry, a user may use a software application and software plug-ins running on a computer to control the audio characteristics of a recording. The software application provides an interface for recording and mixing multiple tracks of audio using a standard mixing console interface. Software plug-ins provide additional specialized interfaces for controlling sound generation and sound processing such as a virtual piano and an audio equalizer. The user has to be situated and sitting at the computer to manipulate the controls of the system and can control one thing at a time with a computer mouse.

The user may also use a physical controller console with buttons, knobs, faders, and text displays. The controller uses a digital messaging protocol for the software to remotely control the software application and plug-ins. This allows a user to control the software application and plug-ins through a local area network (LAN), which provides many benefits of productivity and artistry. The physical interface closely mimics the mixing interface of the software application. But it cannot closely mimic the interface of software plug-ins of which there are thousands with specialized interfaces. To control the plug-ins it uses a protocol that assumes a fixed set of knobs and buttons that make no attempt to resemble the software plug-in interface. The user has to be situated and sitting at the physical controller to manipulate the controls of the system. And when controlling plug-ins, the user has to use extra effort to determine how the physical knobs and buttons are mapped to plug-in interfaces.

To provide the user with additional mobility and control at a lower cost, a remote application on a remote computing device, such as a tablet device, may be used to control the software application and plug-ins. The remote application is configured with controls that are in a layout similar to the physical remote control. The remote application uses the same digital messaging protocol used by the physical remote controller. FIG. 1 shows an example of an interface 100 being displayed on a remote computing device 102. Interface 100 includes various audio controls, such as fader, pan, mute, solo, and track arming controls. Interface 100 is used to control an interface that is displayed on a main computing device. For example, FIG. 2 depicts an example of an interface 200 displayed on a main computing device 201. As shown, interface 200 includes a window 202 that includes controls similar to controls shown on interface 100. Because of the similar relationship, controlling the controls found in window 202 with interface 100 is convenient for a user.

However, interface 201 includes various plug-ins that are provided in sub-windows 204 to allow a user to further control different sets of audio characteristics. For example, a sub-window 204 shows a plug-in that allows a user to control an equalizer. The controls and layout of controls in sub-window 204 are different than the controls and layout of controls provided in interface 100. For example, sub-window 204 includes various knobs that are turned to control the frequency of an audio track. Even though the controls and layout of the controls are different than controls found in interface 100, interface 100 is still used to control the controls found in sub-window 204. For example, a row of knobs 104 in interface 100 may be used to control the knobs shown in sub-window 204. However, the positioning of the knobs in window 100 is different from the knobs shown in window 204. Additionally, the number of knobs shown in interface 100 does not equal the number of knobs shown in window 204. Thus, a user would need to specify which subset of knobs is being controlled in sub-window 204 with the eight knobs shown in interface 100.

### SUMMARY

In one embodiment, a method includes receiving a first input for controlling a first control in a first window for an audio application running on a main computing device being remotely controlled by a remote computing device. The first window is displayed on the main computing device and including a first set of controls. The method then routes the first input to the audio application as a control message to have the application perform the first input. The application controls the first control based on the first input to control a first characteristic of an audio recording. A second input is received for controlling a second control in a sub-window for the audio application. The sub-window is concurrently displayed on the main computing device with the first window and includes a second set of controls and the second input is a movement of the second control on a screen of the remote computing device. The method then causes the movement to be applied to the second control in the sub-window via a mouse event where the audio application is running on the main computing device interprets the mouse event to control a second characteristic of the audio recording.

In one embodiment, a method includes: receiving, on a remote computing device, a first input in a first window including a first set of controls for controlling a first control in a second window for an audio application running on a main computing device, the second window being displayed on the main computing device and including the first set of controls; sending the first input to the audio application as a control message in a control protocol to have the application perform the first input, wherein the application controls the first control based on the control message to control a first characteristic of an audio recording; receiving, on the remote computing device, a second input in a first sub-window including a second set of controls for controlling a second control in a second sub-window for the audio application, the second sub-window being displayed on the main computing device and including the second set of controls, wherein the second input is a movement of the second control on a screen of the remote computing device; and sending the second input to the main computing device, wherein the second input is applied to the second control in the sub-window being displayed on the main computing device via remote control of a mouse, wherein the audio application running on the main computing device interprets the remote control of the mouse to control a second characteristic of the audio recording.

In one embodiment, a non-transitory computer-readable storage medium is provided containing instructions for controlling a computer system to be operable for: receiving a first input for controlling a first control in a first window for an audio application running on a main computing device being remotely controlled by a remote computing device, the first window being displayed on the main computing device and including a first set of controls; routing the first input to the audio application as a control message to have the application perform the first input, wherein the application controls the first control based on the first input to control a first characteristic of an audio recording; receiving a second input for controlling a second control in a sub-window for the audio application, the sub-window being concurrently displayed on the main computing device with the first window and including a second set of controls, wherein the second input is a movement of the second control on a screen of the remote computing device; and causing the movement to be applied to the second control in the sub-window via a mouse event, wherein the audio application running on the main computing device interprets the mouse event to control a second characteristic of the audio recording.

In one embodiment, a non-transitory computer-readable storage medium is provided containing instructions for controlling a computer system to be operable for: receiving, on a remote computing device, a first input in a first window including a first set of controls for controlling a first control in a second window for an audio application running on a main computing device, the second window being displayed on the main computing device and including the first set of controls; sending the first input to the audio application as a control message in a control protocol to have the application perform the first input, wherein the application controls the first control based on the control message to control a first characteristic of an audio recording; receiving, on the remote computing device, a second input in a first sub-window including a second set of controls for controlling a second control in a second sub-window for the audio application, the second sub-window being displayed on the main computing device and including the second set of controls, wherein the second input is a movement of the second control on a screen of the remote computing device; and sending the second input to the main computing device, wherein the second input is applied to the second control in the sub-window being displayed on the main computing device via remote control of a mouse, wherein the audio application running on the main computing device interprets the remote control of the mouse to control a second characteristic of the audio recording.

The following detailed description and accompanying drawings provide a more detailed understanding of the nature and advantages of the present invention.

### BRIEF DESCRIPTION OF THE DRAWINGS

FIG. 1 shows an example of an interface being displayed on a remote computing device.

FIG. 2 depicts an example of an interface displayed on a main computing device.

FIG. 3 depicts a simplified system for remote control of an audio application according to one embodiment.

FIG. 4 depicts an example of an application control window and a vWindow according to one embodiment

FIG. 5 depicts an example of an application window and a plug-in sub-window according to one embodiment

FIG. 6 depicts a more detailed example of the system according to one embodiment.

FIG. 7 depicts a simplified flowchart of a method for providing a user with a menu to control plug-ins according to one embodiment.

FIG. 8 depicts a simplified flowchart of a method for translating between pixel values according to one embodiment.

FIG. 9 depicts a simplified flowchart of a method for managing the focus according to one embodiment.

### DETAILED DESCRIPTION

Described herein are techniques for a remote audio application control system. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

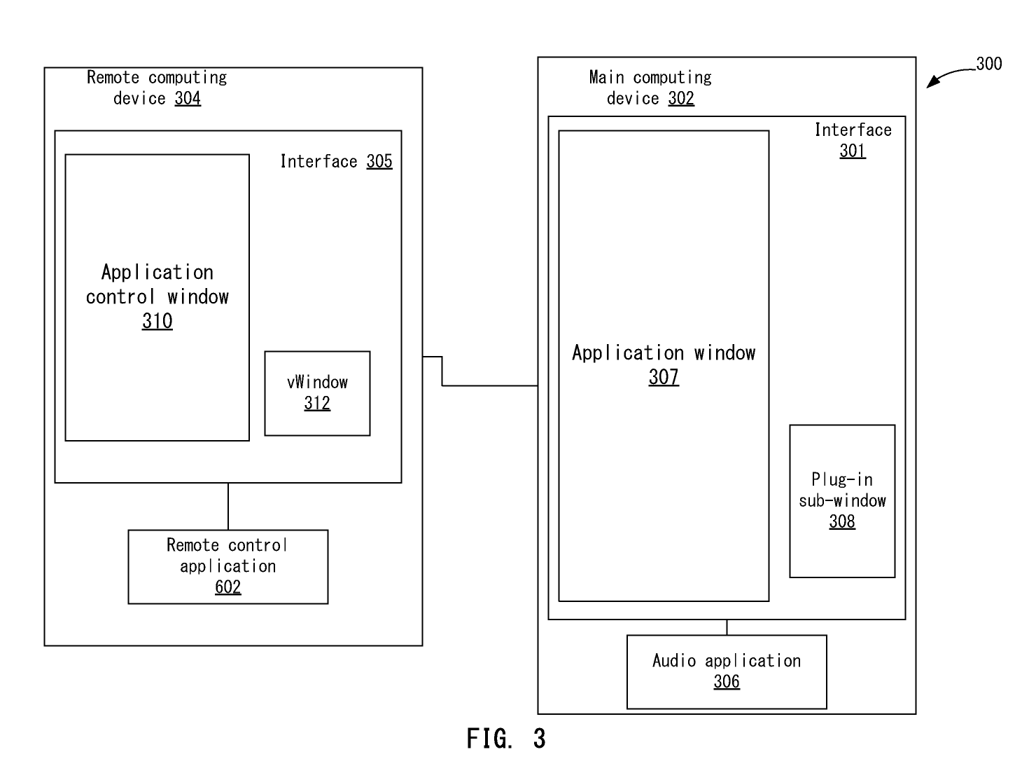

FIG. 3 depicts a simplified system 300 for remote control of an audio application 306 according to one embodiment. System 300 includes a main computing device 302 and a remote computing device 304. Remote computing device 304 communicates with main computing device 302 over a network (not shown). For example, remote computing device 304 may communicate over a local area network (LAN) or a wide area network (WAN). Also, the connection may be through a wireless or wired connection. Main computing device 302 may be a computer, such as a personal computer, work station, or server. Remote computing device 304 is separate from main computing device 302, and may be a mobile device, such as a tablet, laptop computer, or smartphone.

Main computing device 302 is running an audio application 306. Audio application 306 includes controls that are used to control audio characteristics of a recording. An interface 301 includes an application window 307 and a plug-in window 308. Application window 307 displays controls for application 306. A user may manipulate the controls in application window 307 using an input device of main computing device 302.

Application 306 may host a set of plug-ins, which provide specialized audio instrument sound generation and processing for audio applications 306. Plug-ins are adjusted using a set of controls associated with the plug-in. The plug-in provides a sub-window for specialized display and mouse control within application window 307. The specialized display of the controls provides for an attractive, human usable display by mouse. As will be described in more detail below, each plug-in may be displayed in a separate sub-window 308 from application window 307. The plug-in also provides generic, non-visual control information to the hosting application to link generic knobs and buttons on a remote controller that does not mimic the visual interface displayed in the sub-window.

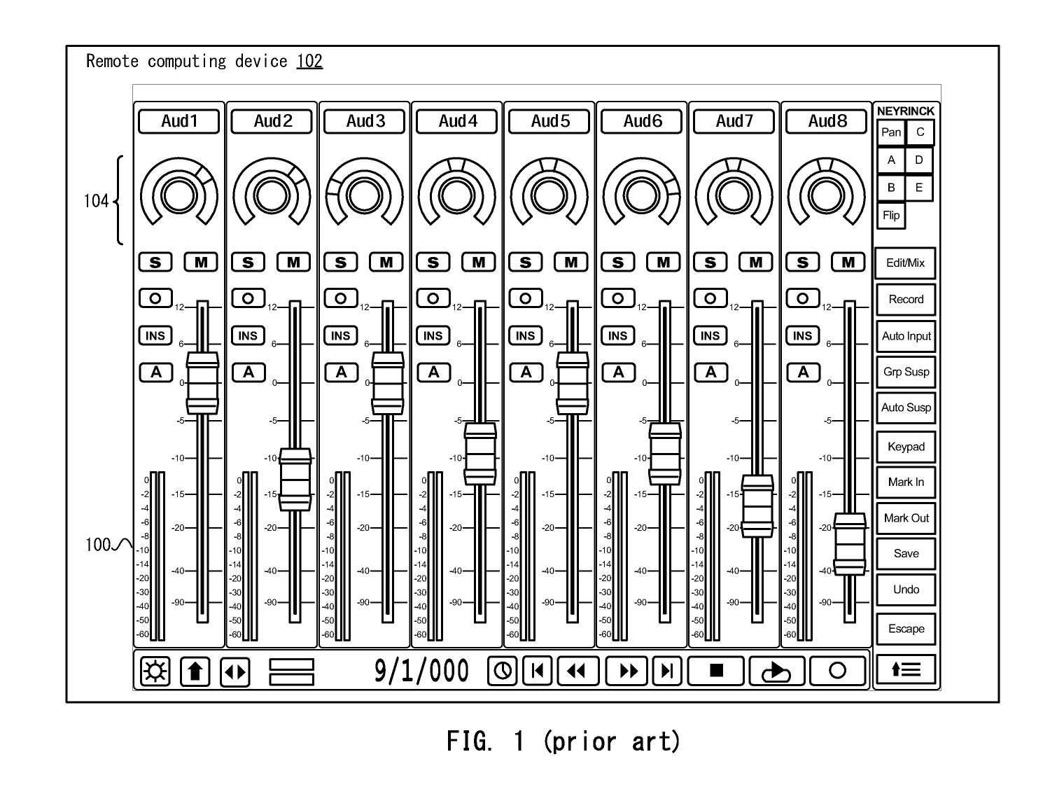

Remote computing device 304 includes a remote control application 602 that is used to remote control application 306. An interface 305 includes an application control window 310 and a vWindow 312. Application control window 310 includes controls that are used to remotely control application 306. For example, application control window 310 may be displaying an interface shown in interface 100 of FIG. 1

Particular embodiments provide vWindow 312 to control plug-in sub-window 308. In one example, vWindow 312 resembles the layout of controls found in a plug-in sub-window 308. For example, vWindow 312 may be a screen capture. In other embodiments, a mockup of plug-in window 308 may be used.

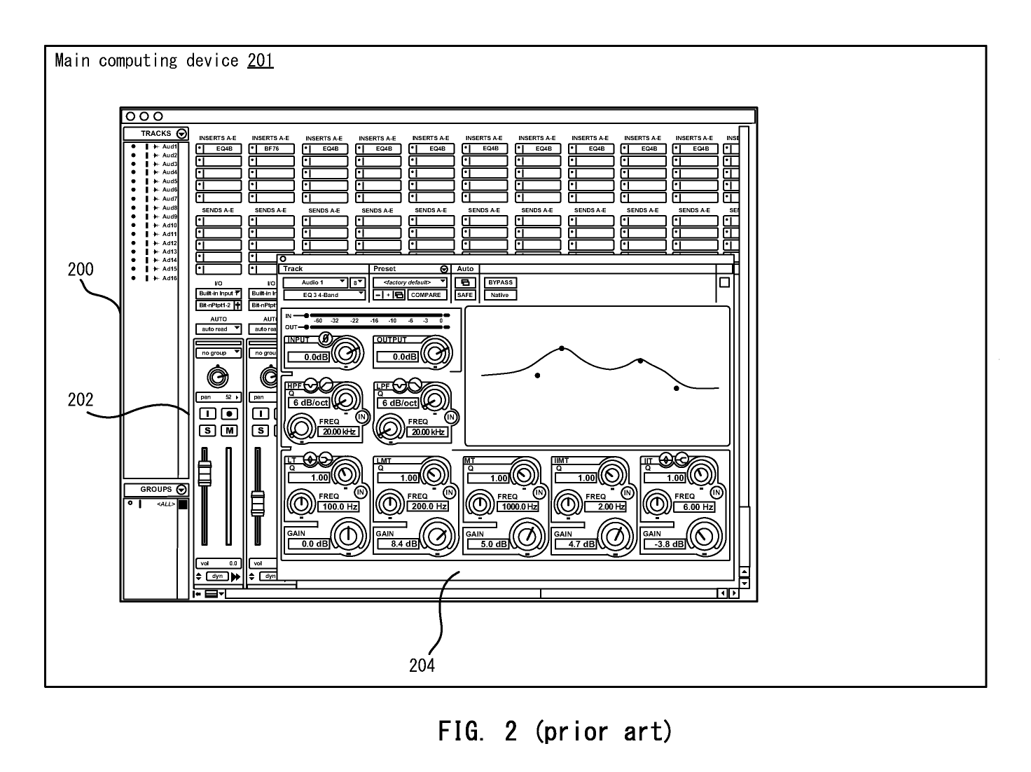

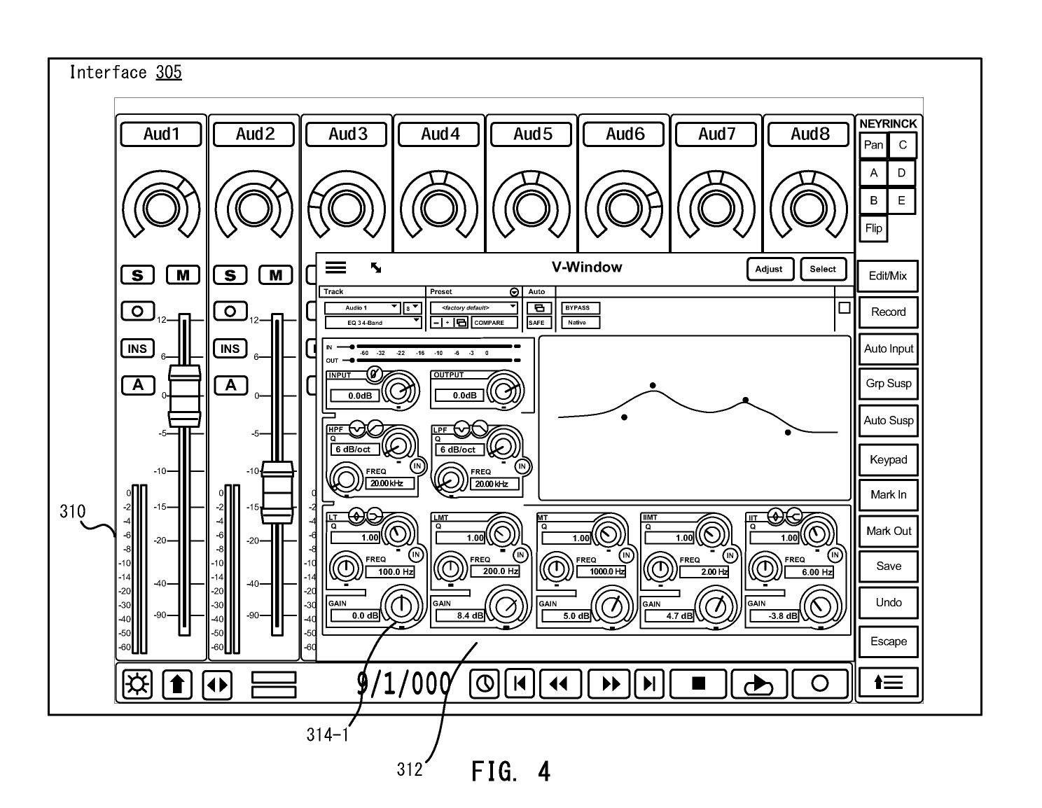

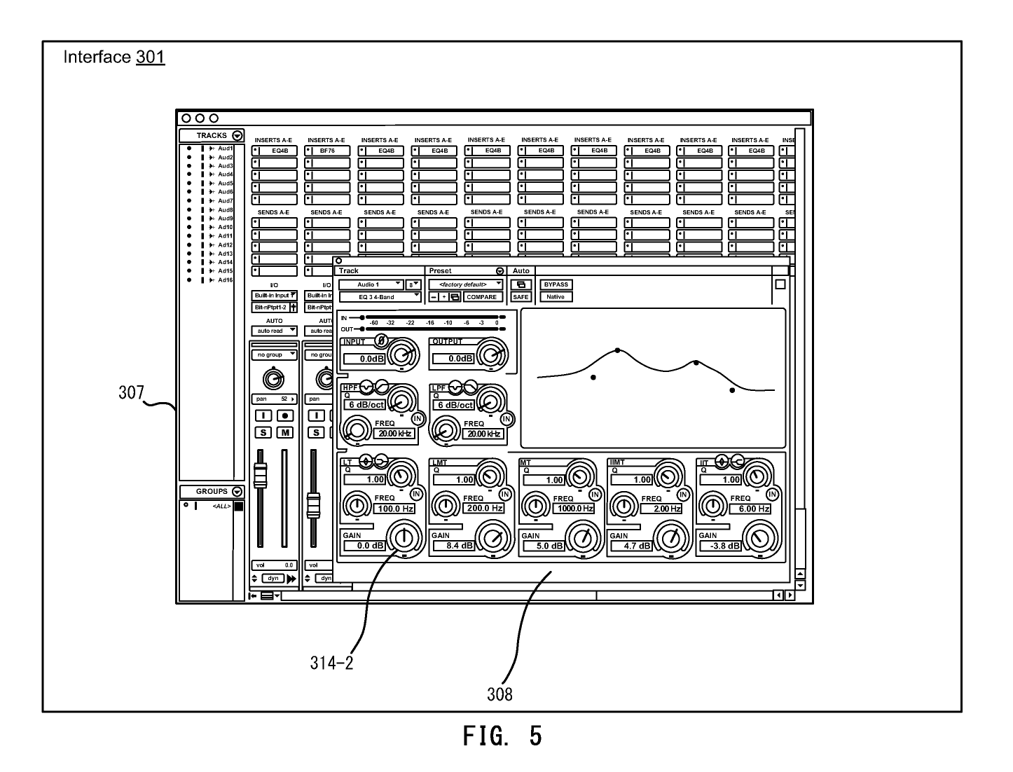

FIG. 4 depicts an example of application control window 310 and vWindow 312 according to one embodiment. Also, FIG. 5 depicts an example of application window 307 and plug-in sub-window 308 according to one embodiment. As shown, application control window 310 and application window 307 are the same as shown in FIGS. 1 and 2. However, vWindow 312 mirrors the controls and control layout shown in plug-in sub-window 308. A user may then control certain controls on vWindow 312, such as a control 314-1, to control a corresponding control 314-2 in plug-in sub-window 308. For example, a user may turn an input knob 314-1 to control the corresponding input knob 314-2. Input knob 314-1 is in the same position of the control layout and also performs the same function (i.e., it turns) as input knob 314-2. The same is true for the other controls shown in vWindow 312 and plug-in sub-window 308.

Application control window 310 controls application window 307 via an application control protocol. For example, a proprietary control protocol for application 306 may be used to control application 306. When a control in application control window 310 is adjusted, a control message is sent from remote computing device 304 to main computing device 302 to adjust the corresponding control. As will be described below, a control point adjusts the control in application 306 based on the control message. vWindow 312 controls plug-in sub-window 308 via another channel. For example, instead of sending control messages, input on vWindow 312 may be used to remote control a mouse on plug-in sub-window 308. For example, a mouse event received on vWindow 312 is transferred through an operating system running on main computing device 302 and applied to plug-in sub-window 308. This mouse input may turn a control knob. The control in this case is adjusted by virtue of the mouse input being applied to sub-window 308 to turn the control knob.

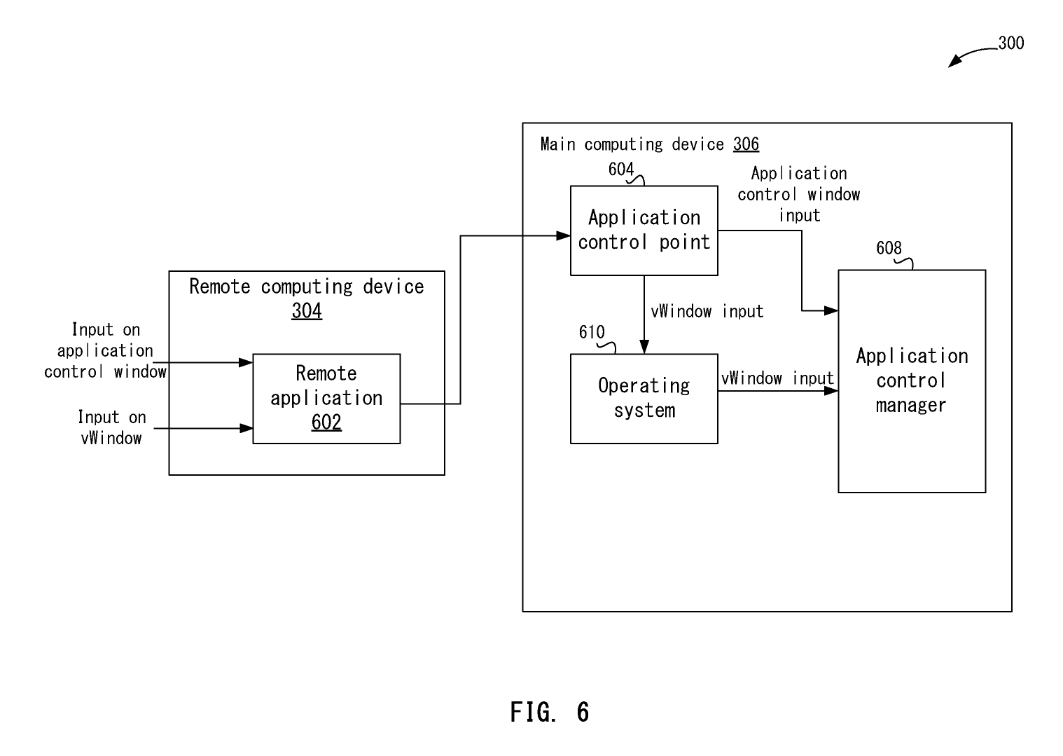

FIG. 6 depicts a more detailed example of system 300 according to one embodiment. Remote control application 602 executes on remote computing device 304. Remote control application 602 is configured to receive user input via application control window 310 or vWindow 312 and remotely control application 306. For example, if a touch screen is being used, a user may touch application control window 310 to provide a user input for a control in application control window 310 or touch vWindow 312 to provide a user input to control a control plug-in sub-window 308.

Remote control application 602 receives the input and sends the input to main computing device 302. In one example, when input is detected in application control window 310, then the application control protocol is used to communicate the input in a control message to main computing device 302. The control message may communicate what control was changed. However, when input is detected in vWindow 312, another control protocol, such as a remote desktop protocol (RDP), is used to communicate the input to main computing device 302. For example, the movement of the mouse is communicated rather than what control was changed.

An application control point 604 receives the user input and determines how to apply the user input to application 306. For example, application control point 604 may communicate an application control manager 608 using the application control protocol. Application control manager 608 may be logic for application 306 that receives input and applies the input to application 306. Application control manager 608 can then control application 306. For example, a mouse input on application control window 310 may move a slider up or down. The moving of the slider is translated by remote control application 602 into a control message sent to application control point 604. Application control point 604 can then send the control message to application control manager 608 indicating that an audio characteristic associated with the slider in application window 307 should be adjusted. Also, the slider in application window 307 is moved visually based on the user input. In another embodiment, application control point 604 may receive mouse events and can then translate the mouse event into a control message. For example, application control point 604 determines that the mouse event moved the slider and translates this movement into a control message indicating the slider is to be moved.

When an input on vWindow 312 is received at application control point 604, application control point 604 may apply the input via a different channel than the input received from application control window 310. For example, the input is applied to an operating system 610 that is running on main computing device 306. Operating system 610 manages applications running on main computing device 302 including application 306. Operating system 610 is bypassed when the application control protocol is used. However, when input in vWindow 312 is received, operating system 610 applies the input to application control manager 608. For example, the input on vWindow 312 may be a mouse event that moves a mouse on vWindow 312. In one example, the mouse event may be a user touching vWindow 312 and turning a knob via the touch. It will be understood that a mouse event may be any movement indicated by a user input and is not limited to moving a mouse or cursor. This mouse event is sent to application control point 604. Application control point 604 determines the input was received in vWindow 312 and sends the mouse event to operating system 610. This mouse event indicates to operating system 610 that a user has manipulated a mouse on vWindow 312. The corresponding mouse event is then forwarded to application control manager 608, which performs the mouse event on plug-in sub-window 308 (i.e., the mouse on main computing device 302 is being remote controlled). For example, the mouse event that turns a knob in vWindow 312 is forwarded and applied to turn the same knob on plug-in sub-window 308. This mouse event, however, does not specify that this control should be adjusted. Rather, operating system 610 is applying the corresponding mouse event on plug-in sub-window 308. For example, a mouse is remotely controlled on plug-in sub-window 308 to apply a corresponding movement, which in turn turns the knob in plug-in sub-window 308. This is akin to a user using main computing device 302 to turn the knob. However, in this case, the knob is being remote controlled.

In one embodiment, a virtual desktop infrastructure (VDI) is used to translate mouse events on remote computing device 304 to mouse events on main computing device 302. The mouse events do not use the control protocol that is used to perform controls from application control window 310. Rather, a mouse event on vWindow 312 is used to remote control a mouse on plug-in sub-window 308. In one embodiment, the remote control session remotely controls the mouse on main computing device 302 on entire interface 301. However, only mouse events on vWindow 312 are applied on plug-in window 308 by virtue of focus being on plug-in window 308. Although VDI is described, other remote control protocols may also be used to remotely control a mouse of main computer 302.

In this way, a user may control both application window 307 and plug-in sub-window 308 from remote computing device 304. Conventionally, the controls of application control window 310 were used to control plug-in window 308, and thus both application control window 310 and plug-in sub-window 308 could not be controlled at the same time. However, the use of two different channels allows a user to control application control window 310 and vWindow 312. Also, the remote control of a mouse to control plug-in sub-window 308 allows a similar interface to be displayed in vWindow 312. By displaying a similar window in vWindow 312, the user can control the controls of plug-in sub-window 308 in a normal manner as if the user was using main computing device 302. This provides a user with a familiar experience with controlling plug-in sub-window 308 even though remote computing device 304 is being used.

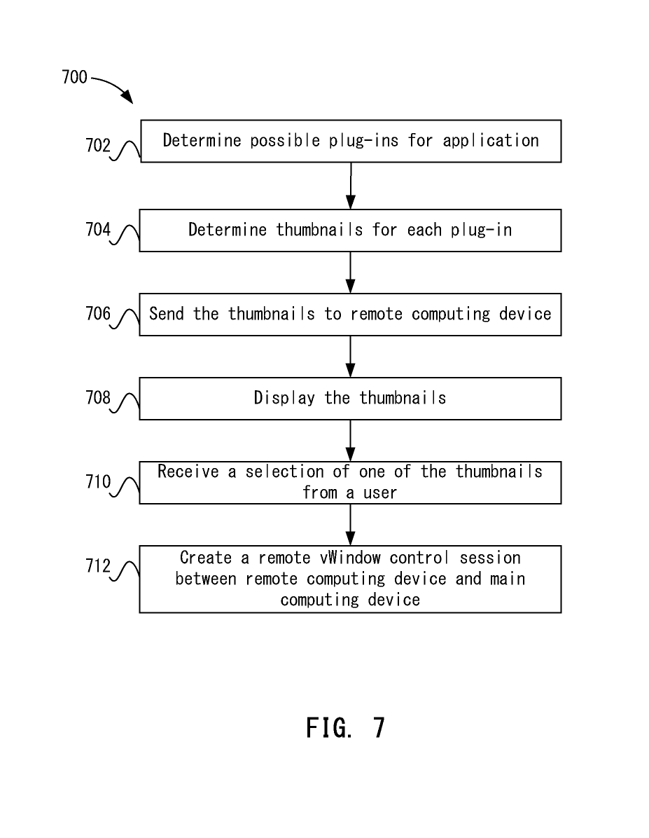

Multiple plug-ins for application 306 may be controlled. FIG. 7 depicts a simplified flowchart 700 of a method for providing a user with a menu to control plug-ins according to one embodiment. At 702, application control manager 608 determines possible plug-ins for application 306. For example, each plug-in may be associated with a set of functions that can be controlled. Also, applications other than plug-ins may be determined. For example, application control manager 608 determines all application windows that are open on main computing device 302.

At 704, application control manager 608 determines thumbnails for each plug-in. For example, each plug-in may have a different user interface for the controls of the plug-in. A thumbnail for each plug-in showing the layout of controls is determined. The thumbnail may be a screenshot or mock up of the plug-in.

At 706, the thumbnails are sent to remote computing device 304. For example, the thumbnails may be sent when a user session is established between remote computing device 304 and main computing device 302. Or, the thumbnails may be sent when a user requests the thumbnails. For example, the user may want to select one of the plug-ins to display in vWindow 312 and a list of possible plug-ins is sent. At 708, remote computing device 304 displays the thumbnails. At 710, a selection of one of the thumbnails is received from a user. For example, a user may scan the displayed thumbnails and determine which plug-in the user wants to control.

At 712, a remote vWindow control session is created between remote computing device 304 and main computing device 302. For example, a remote desktop control session is created that allows mouse events on remote computing device 304 to be applied to main computing device 302. The remote desktop session may only be applicable when vWindow 308 is controlled. When application control window 310 is controlled, the application control protocol is used.

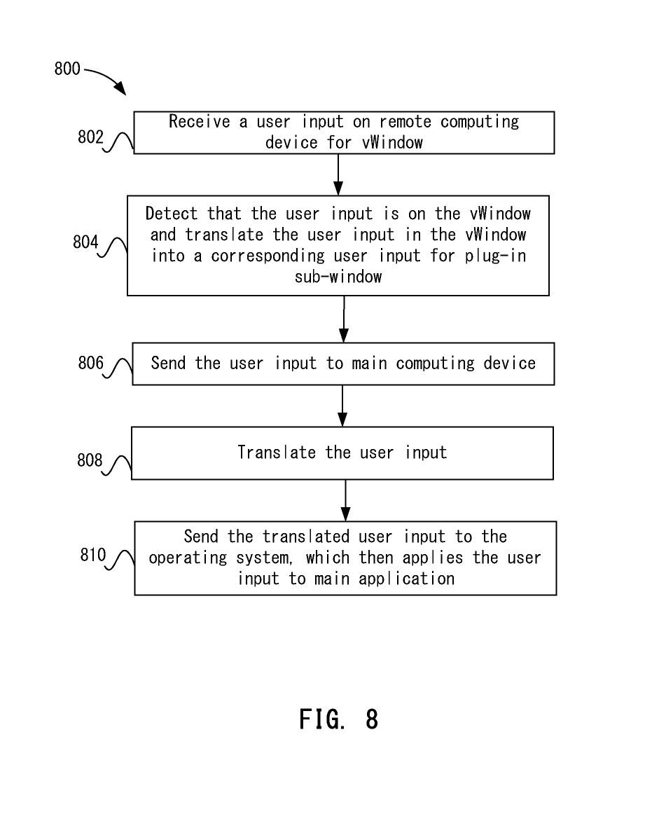

Remote computing device 304 may be of a different form factor than main computing device 302. For example, the screen of remote computing device 304 may be a different size from the screen of main computing device 302. Thus, a user input at certain pixel values on remote computing device 304 does not directly translate to the same pixel values on main computing device 302. A translation is performed to apply mouse input on vWindow 312 to plug-in sub-window 308. FIG. 8 depicts a simplified flowchart 800 of a method for translating between pixel values according to one embodiment. At 802, remote control application 602 receives a user input on remote computing device 304 for vWindow 312. For example, the user input may be a touch input where the user touches a screen of remote computing device 304 where vWindow 312 is displayed. At 804, remote computing device 304 detects that the user input is on vWindow 312 and translates the user input in vWindow 312 into a corresponding user input for plug-in sub-window 308.

At 806, remote computing device 304 sends the user input to main computing device 302. For example, the pixel values of the touch input may be sent to main computing device 302. At 808, application control point 604 translates the user input. For example, application control point 604 knows a position of plug-in sub-window 308 being displayed on a display of main computing device 302 and knows the position of vWindow 312 being displayed on remote computing device 304. Application control point 604 can then translate the position of the user input on remote computing device 304 to a corresponding user input for main computing device 302. For example, application control point 604 translates pixel values such that a mouse event on vWindow 312 corresponds to a similar user input on plug-in sub-window 308.

At 808, application control point 604 sends the translated user input to operating system 610, which then applies the user input to main application 606. Thus, the touch input on vWindow 312 is translated into a corresponding input to move a mouse on plug-in sub-window 308. Based on the touch input, main application 606 performs an action. For example, the input on plug-in sub-window 308 may turn a knob and main application 606 processes the turning of the knob to perform a function. This is the same processing that would be performed if a user was using main computing device 302 to use a mouse to turn the same knob that was remote controlled.

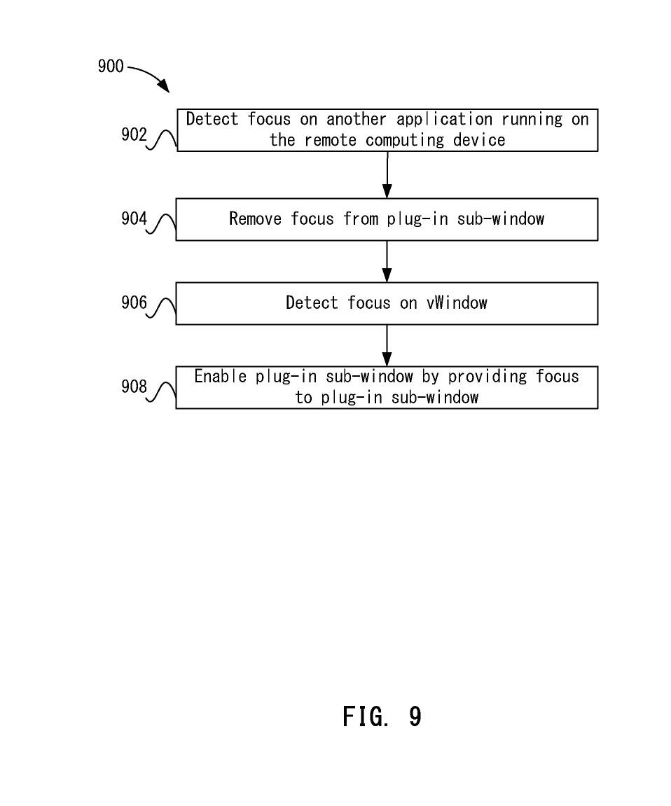

Because mouse events are being applied to plug-in sub-window 308, focus on plug-in sub-window 308 may be needed. For example, when operating system 610 applies a mouse event to main computing device 302, because the focus is on plug-in sub-window 308, the input is applied to plug-in sub-window 308. If the focus was not on plug-in sub-window 308, the mouse input would be applied to another application. FIG. 9 depicts a simplified flowchart 900 of a method for managing the focus according to one embodiment. At 902, application control manager 608 detects focus on another application running on remote computing device 304. For example, the focus on remote computing device 304 may be switched to application control window 310. At 904, main computing device 302 removes focus from plug-in sub-window 308. For example, plug-in sub-window 308 may be disabled by darkening it. In this case, mouse events are applied to other windows that may be open on main computing device 302.

At 906, main computing device 302 detects focus on vWindow 312. At 908, main computing device 302 enables plug-in sub-window 308 by providing focus to plug-in sub-window 308. For example, a focus event may be sent from remote control application 602 to application control point 604. The focus event is then forwarded to operating system 610, which forwards the focus event to application control manager 608. Application control manager 608 then interprets the focus event to enable focus on plug-in sub-window 308. For example, the focus event may be a user touching vWindow 308, which causes main computer 302 to select plug-in sub-window 308. Thus, when focus is detected on vWindow 308, mouse events are sent. Also, when focus is detected on application control window 310, control messages are sent.

Accordingly, particular embodiments provide a remote audio control application that allows control of application window 307 and plug-in sub-window 308. Two channels are used to control both windows. Also, this allows vWindow 312 to be similar to plug-in sub-window 308.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
receiving a first input for controlling a first control in a first window for an audio application running on a main computing device being remotely controlled by a remote computing device, the first window being displayed on the main computing device and including a first set of controls;
routing the first input to the audio application as a control message to have the application perform the first input, wherein the application controls the first control based on the first input to control a first characteristic of an audio recording;
receiving a second input for controlling a second control in a sub-window for the audio application, the sub-window being concurrently displayed on the main computing device with the first window and including a second set of controls, wherein the second input is a movement of the second control on a screen of the remote computing device; and
causing the movement to be applied to the second control in the sub-window via a mouse event, wherein the audio application running on the main computing device interprets the mouse event to control a second characteristic of the audio recording.

2. The method of claim 1, wherein:
the second input comprises a mouse event on a sub-window being displayed on the screen associated with the remote computing device, and
the mouse event is performed on the main computing device to cause the movement of the second control on the sub-window being displayed on a screen associated with the main computing device.

3. The method of claim 2, further comprising translating coordinates from the mouse event on the sub-window being displayed on the screen associated with the remote computing device to coordinates for the sub-window being displayed on the screen associated with the main computing device, wherein the translation is determined based on a position of the sub-window being displayed on the screen associated with the remote computing device and a position of the sub-window being displayed on the screen associated with the main computing device.

4. The method of claim 1, further comprising initiating a remote control session between the remote computing device and the main computing device in a first communication channel, wherein the remote control session allows a mouse to be controlled on the main computing device via the remote computing device when a mouse is controlled in the sub-window being displayed on the screen associated with the remote computing device.

5. The method of claim 4, further comprising initiating an application control session between the remote computing device and the main computing device in a second communication channel, wherein the application control session allows controls in the first window to be controlled on the main computing device via the remote computing device when controls in a second window are controlled on the remote computing device.

6. The method of claim 1, wherein the movement is applied to the sub-window being displayed on the main computing device when a focus is on the sub-window.

7. The method of claim 6, wherein the control message is routed to the audio application without having the operating system apply the first input to the audio application.

8. The method of claim 1, wherein a sub-window being displayed on the remote computing device includes a similar control layout as included in the sub-window being displayed on the main computing device.

9. The method of claim 1, further comprising:
determining a plurality of sub-windows for the audio application, each sub-window controlling a set of controls for the audio application;
determining a plurality of thumbnails showing a control layout of a sub-window for each of the plurality of sub-windows; and
displaying the plurality of thumbnails for selection of one of the thumbnails to allow control of a sub-window associated with the one of the thumbnails.

10. A method comprising:
receiving, on a remote computing device, a first input in a first window including a first set of controls for controlling a first control in a second window for an audio application running on a main computing device, the second window being displayed on the main computing device and including the first set of controls;
sending the first input to the audio application as a control message in a control protocol to have the application perform the first input, wherein the application controls the first control based on the control message to control a first characteristic of an audio recording;
receiving, on the remote computing device, a second input in a first sub-window including a second set of controls for controlling a second control in a second sub-window for the audio application, the second sub-window being displayed on the main computing device and including the second set of controls, wherein the second input is a movement of the second control on a screen of the remote computing device; and
sending the second input to the main computing device, wherein the second input is applied to the second control in the sub-window being displayed on the main computing device via remote control of a mouse, wherein the audio application running on the main computing device interprets the remote control of the mouse to control a second characteristic of the audio recording.

11. The method of claim 10, further comprising initiating a remote control session between the remote computing device and the main computing device in a first communication channel, wherein the remote control session allows the mouse to be remotely controlled on the main computing device via the remote computing device when controls in the sub-window are controlled.

12. The method of claim 11, further comprising initiating an application control session between the remote computing device and the main computing device in a second communication channel, wherein the application control session allows controls in the first window to be controlled on the main computing device via the remote computing device when controls in the first window are controlled.

13. The method of claim 10, wherein the second input comprises a touch input on the screen of the remote computing device.

14. The method of claim 10, wherein the sub-window on the remote computing device includes a similar control layout as included in the sub-window on the main computing device.

15. A non-transitory computer-readable storage medium containing instructions for controlling a computer system to be operable for:
receiving a first input for controlling a first control in a first window for an audio application running on a main computing device being remotely controlled by a remote computing device, the first window being displayed on the main computing device and including a first set of controls;
routing the first input to the audio application as a control message to have the application perform the first input, wherein the application controls the first control based on the first input to control a first characteristic of an audio recording;
receiving a second input for controlling a second control in a sub-window for the audio application, the sub-window being concurrently displayed on the main computing device with the first window and including a second set of controls, wherein the second input is a movement of the second control on a screen of the remote computing device; and
causing the movement to be applied to the second control in the sub-window via a mouse event, wherein the audio application running on the main computing device interprets the mouse event to control a second characteristic of the audio recording.

16. The non-transitory computer-readable storage medium of claim 15, wherein:
the second input comprises a mouse event on a sub-window being displayed on the screen associated with the remote computing device, and
the mouse event is performed on the main computing device to cause the movement of the second control on the sub-window being displayed on a screen associated with the main computing device.

17. The non-transitory computer-readable storage medium of claim 15, further comprising initiating a remote control session between the remote computing device and the main computing device in a first communication channel, wherein the remote control session allows a mouse to be controlled on the main computing device via the remote computing device when a mouse is controlled in the sub-window being displayed on the screen associated with the remote computing device.

18. The non-transitory computer-readable storage medium of claim 17, further comprising initiating an application control session between the remote computing device and the main computing device in a second communication channel, wherein the application control session allows controls in the first window to be controlled on the main computing device via the remote computing device when controls in a second window are controlled on the remote computing device.

19. A non-transitory computer-readable storage medium containing instructions for controlling a computer system to be operable for:
receiving, on a remote computing device, a first input in a first window including a first set of controls for controlling a first control in a second window for an audio application running on a main computing device, the second window being displayed on the main computing device and including the first set of controls;
sending the first input to the audio application as a control message in a control protocol to have the application perform the first input, wherein the application controls the first control based on the control message to control a first characteristic of an audio recording;
receiving, on the remote computing device, a second input in a first sub-window including a second set of controls for controlling a second control in a second sub-window for the audio application, the second sub-window being displayed on the main computing device and including the second set of controls, wherein the second input is a movement of the second control on a screen of the remote computing device; and
sending the second input to the main computing device, wherein the second input is applied to the second control in the sub-window being displayed on the main computing device via remote control of a mouse, wherein the audio application running on the main computing device interprets the remote control of the mouse to control a second characteristic of the audio recording.

20. The non-transitory computer-readable storage medium of claim 19, wherein the sub-window on the remote computing device includes a similar control layout as included in the sub-window on the main computing device.
